(19) United States
(12) Patent Application Publication
(10) Pub. No.: US 2012/0162670 A1
(43) Pub. Date: Jun. 28, 2012

(54) MULTI-BEAM IMAGE FORMING APPARATUS AND ELECTROSTATIC LATENT IMAGE FORMATION METHOD

(75) Inventors: Kenichi Ohnishi, Osaka-shi (JP); Okito Ogasahara, Osaka-shi (JP)

(73) Assignee: KYOCERA MITA CORPORATION, Osaka-shi (JP)

(21) Appl. No.: 13/329,620

(22) Filed: Dec. 19, 2011

(30) Foreign Application Priority Data
Dec. 27, 2010 (JP) 2010-290112
Dec. 27, 2010 (JP) 2010-290113
Dec. 28, 2010 (JP) 2010-291733

(51) Int. Cl. G06K 1/00

(52) U.S. Cl. 358/1.4

(57) ABSTRACT

An image forming apparatus includes a pattern formation control unit for forming a plurality of evaluation patterns by repeatedly turning on and off a plurality of light emitters arranged in a row in units of n dots (n is an integer equal to or greater than 1) to irradiate light to a photoconductor while changing write timings of the respective light emitters in a predetermined range, an adjustment unit for improving reliability of density difference information among the plurality of evaluation patterns, and a determination unit for obtaining information on densities of the respective evaluation patterns based on a detection result on the densities of the respective evaluation patterns and determining write timings derived from the evaluation pattern having the lowest or highest density as the write timings of the plurality of light emitters.

### CROSS REFERENCE TO RELATED APPLICATION

This application is based on Japanese Patent Appl. Nos. 2010-290112, 2010-290113 and 2010-291733 filed in the Japanese Patent Office on Dec. 27, 2010, December 27, 2010 and Dec. 28, 2010, the contents of which are hereby incorporated by reference.

### BACKGROUND OF THE INVENTION

The present discloser relates to a multi-beam image forming apparatus capable of precisely adjusting write timings of respective light beams and an electrostatic latent image formation method.

In response to a request to speed up an image output, multi-beam image forming apparatuses are being developed in which a photoconductive drum is simultaneously scanned with laser beams from a multi-beam laser composed of a plurality of light emitters. In such an image forming apparatus, it is necessary to control write timings of the respective laser beams and precisely match writing positions on the photoconductive drum in a main scanning direction. As its conventional technology, a method is known in which an image forming apparatus is caused to output evaluation patterns and writing positions are matched by detecting phase shifts in the main scanning direction based on densities of the evaluation patterns.

However, in the method of the above conventional technology, the densities of the evaluation patterns may not be precisely detected if there is density unevenness or density variation resulting from developing characteristics, jitter caused by a conveyance system such as a transfer belt or the like. In this case, there has been a possibility that the write timings of the respective laser beams cannot be accurately matched. An object of the present discloser is to provide an image forming apparatus capable of precisely adjusting write timings in a main scanning direction by precisely grasping densities of evaluation patterns, and an electrostatic latent image formation method.

### SUMMARY OF THE INVENTION

To achieve the object, one aspect of the present disclosure is directed to an image forming apparatus, including: an image forming unit including a photoconductor and a light source with a plurality of light emitters arranged in a row at a predetermined interval and at a predetermined angle with respect to a main scanning direction of the photoconductor and adapted to form an electrostatic latent image on the photoconductor by emitting light corresponding to image data from the light source and form a toner image by developing the electrostatic latent image formed on the photoconductor with toner; a detection unit for detecting a density of the toner image; a pattern formation control unit for forming a plurality of evaluation patterns by repeatedly turning on and off the light emitters in units of n dots (n is an integer equal to or greater than 1) to irradiate light to the photoconductor while changing write timings of the respective light emitters in a predetermined range; an adjustment unit for improving reliability of density difference information among the plurality of evaluation patterns; and a determination unit for obtaining information on densities of the respective evaluation patterns based on a detection result on the densities of the respective evaluation patterns by the detection unit and determining write timings derived from the evaluation pattern having the lowest or highest density as the write timings of the plurality of light emitters.

Another aspect of the present discloser is directed to an electrostatic latent image formation method for forming an electrostatic latent image on a photoconductor by emitting light corresponding to image data from a light source, using the photoconductor and the light source with a plurality of light emitters arranged in a row at a predetermined interval and at a predetermined angle with respect to a main scanning direction of the photoconductor, including: forming a plurality of evaluation patterns by repeatedly turning on and off the light emitters in units of n dots (n is an integer equal to or greater than 1) to irradiate light to the photoconductor while changing write timings of the respective light emitters in a predetermined range; performing an adjustment process of improving reliability of density difference information among the plurality of evaluation patterns; detecting densities of the respective evaluation patterns; obtaining information on the densities of the respective evaluation patterns based on a detection result on the densities; and determining write timings derived from the evaluation pattern having the lowest or highest density as the write timings of the plurality of light emitters.

These and other objects, features and advantages of the present discloser will become more apparent upon reading the following detailed description along with the accompanying drawings.

### BRIEF DESCRIPTION OF THE DRAWINGS

FIG. 1 is a sectional view showing the internal structure of an image forming apparatus.

FIG. 2 is a block diagram showing the electrical construction of an image forming apparatus according to a first embodiment of the discloser.

FIG. 3 is a perspective view diagrammatically showing a state where a laser beam is irradiated to a light polarization surface of a polygon mirror.

FIG. 4 is a block diagram showing a laser beam irradiation control system.

FIG. 5 is a perspective view showing the external appearance of a light source.

FIG. 6 is a plan view showing an example of an evaluation chart.

FIGS. 7A to 7C are views enlargedly and diagrammatically showing dots of the evaluation chart.

FIG. 8 is a graph comparing average densities of the evaluation charts.

FIG. 9 is a plan view showing an example of an evaluation chart to which the first embodiment is applied.

FIG. 10 is a flow chart showing a process of adjusting write timings of laser diodes in the first embodiment.

FIG. 11 is a block diagram showing the electrical construction of an image forming apparatus according to a second embodiment of the discloser.

FIG. 12 is a view diagrammatically showing dots formed when the light quantity of a light source is small.

FIG. 13 is a view diagrammatically showing dots to which the second embodiment is applied.

FIG. 14 is a flow chart showing a process of adjusting write timings of laser diodes in the second embodiment.

FIG. 15 is a block diagram showing the electrical construction of an image forming apparatus according to a third embodiment of the discloser.

FIG. 16 is a plan view showing an example of evaluation charts to which the third embodiment is applied.

FIGS. 17A to 17F are views showing a shift cycle.

FIG. 18 is a plan view showing an example of evaluation charts to which a modification of the third embodiment is applied.

### DETAILED DESCRIPTION OF THE PREFERRED EMBODIMENTS

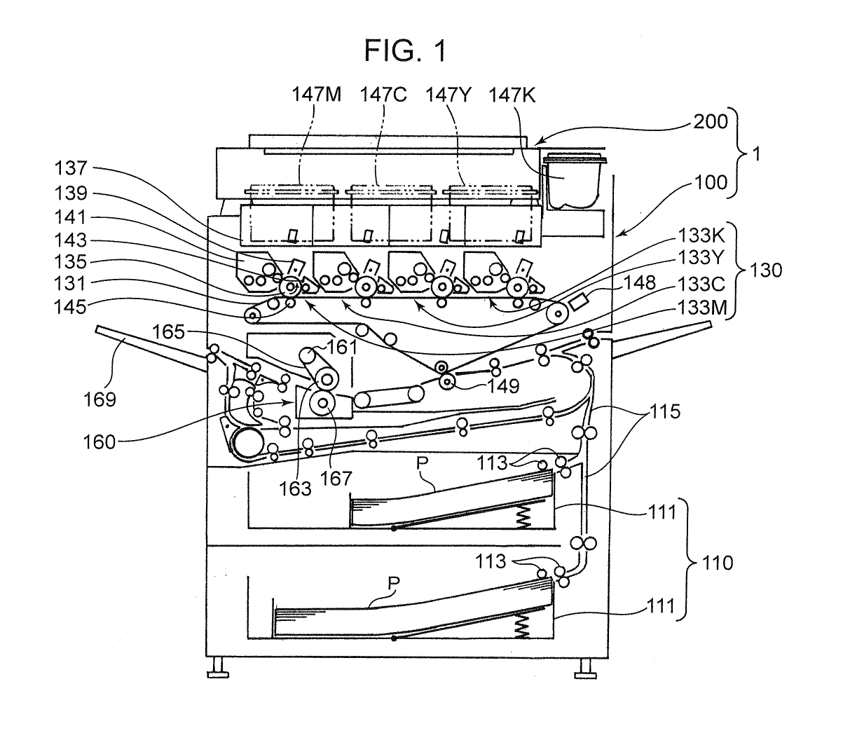

Hereinafter, embodiments of the present disclosure are described in detail with reference to the drawings. FIG. 1 is a sectional view schematically showing the internal structure of an image forming apparatus 1 according to one embodiment of the present discloser. The image forming apparatus 1 may be, for example, a complex machine having copy, printer and facsimile functions. The image forming apparatus 1 is of a tandem type and includes an apparatus main body 100 and an image reading unit 200 arranged on the apparatus main body 100.

The image reading unit 200 reads an image (characters, figure, picture or the like) using a CCD (Charge Coupled Device) or the like and outputs the read image as image data. The image reading unit 200 has a function of reading a color image. This enables color copying and facsimile transmission.

The apparatus main body 100 includes a sheet storage unit 110, an image forming unit 130 and a fixing unit 160.

The sheet storage unit 110 is arranged in a bottommost part of the apparatus main body 100 and includes sheet cassettes 111 capable of storing a stack of sheets P. The sheet cassettes 111 are mounted by being inserted into the apparatus main body 100. For replenishment of sheets P, a user pulls the sheet cassettes 111 out of the apparatus main body 100. The uppermost sheet P in the stack of the sheets P stored in each sheet cassette 111 is fed to a sheet conveyance path 115 by driving pickup rollers 113. The sheet P is conveyed to the image forming unit 130 via the sheet conveyance path 115.

The image forming unit 130 forms a toner image on a sheet P conveyed from the sheet cassette 111. The image forming unit 130 includes a magenta unit 133M, a cyan unit 133C, a yellow unit 133Y and a black unit 133K arranged in an order in which toner images are transferred to a transfer belt 131. These units have a similar construction and, hence, are described, taking the magenta unit 133M as an example.

The magenta unit 133M includes a photoconductive drum 135 (photoconductor) and an exposure device 137. A charger 139, a developing device 141 and a cleaner 143 are arranged around the photoconductive drum 135. The charger 139 uniformly charges the circumferential surface of the photoconductive drum 135. The exposure device 137 generates light corresponding to magenta image data out of image data (image data output from the image reading unit 200, image data transmitted from a personal computer, facsimile-received image data or the like) and irradiates the uniformly charged circumferential surface of the photoconductive drum 135 with this light. Although described in detail later, the exposure device 137 is a multi-beam exposure device which includes a plurality of light emitters and simultaneously scans a plurality of light beams. This causes an electrostatic latent image of a magenta pattern to be formed on the circumferential surface of the photoconductive drum 135. In this state, magenta toner is supplied from the developing device 141 to the circumferential surface of the photoconductive drum 135, thereby forming a toner image of the magenta pattern on this circumferential surface.

The transfer belt 131 can rotate clockwise while being sandwiched between the photoconductive drums 135 and primary transfer rollers 145. The toner image of the magenta pattern is transferred to the transfer belt 131 from the photoconductive drum 135. The magenta toner remaining on the circumferential surface of the photoconductive drum 135 is removed by the cleaner 143. The above is the description of the magenta unit 133M.

Containers containing toners of the corresponding colors, i.e. a magenta toner container 147M, a cyan toner container 147C, a yellow toner container 147 and a black toner container 147 K are arranged above the magenta unit 133M, the cyan unit 133C, the yellow unit 133Y and the black unit 133K. The toners are supplied to the developing devices 141 of the respective colors from the corresponding containers.

As described above, the toner image of the magenta pattern is transferred to the transfer belt 131, a toner image of a cyan pattern is transferred onto this toner image, and a toner image of a yellow pattern and that of a black pattern are similarly transferred in a superimposition manner. In this way, a full color toner image is formed on the transfer belt 131. By transferring the toner images of the respective color patterns to the transfer belt 131 in a superimposition manner in this way, the full color toner image is formed on the transfer belt 131. The full color toner image is transferred to a sheet P conveyed from the sheet storage unit 110 by a secondary transfer roller 149.

The sheet P having the full color toner image transferred thereto is conveyed to the fixing unit 160. The fixing unit 160 includes a heating roller 161, a fixing roller 163 and a fixing belt 165 mounted between these rollers. The fixing belt 165 is sandwiched between the fixing roller 163 and a pressure roller 167. The sheet P having the full color toner image transferred thereto is sandwiched by these rollers. In this way, heat and pressure are applied to the full color toner image and the sheet P and the full color toner image is fixed to the sheet P. The sheet P after a fixing process is discharged to a discharge tray 169.

The image forming unit 130 includes a density sensor 148 (detection unit). The density sensor 148 detects an optical density of a toner image transferred onto the transfer belt 131. The density sensor 148 is, for example, a specular reflection sensor for detecting reflected light and includes an LED light source inclined at a predetermined angle with respect to a detection position on the surface of the transfer belt 131, a phototransistor as a light receiving element and the like. Light is irradiated from the LED light source to the toner image on the transfer belt 131 and the amount of the reflected light is detected by the photoresistor, whereby the optical density (hereinafter, merely written as “density”) of the toner image is measured. A measurement result of the density sensor 148 is converted into an electrical signal and output to a control unit 300 (300A to 300C) to be described later. Note that the density sensor 148 only has to be a sensor capable of detecting density information of a toner image and may be, for example, a sensor capable of detecting a density from an image obtained by picking up a toner image.

In the multi-beam image forming apparatus, it is necessary to control write timings of respective light beams and precisely match writing positions of the respective light beams on the photoconductive drum 135 in a main scanning direction. For this timing adjustment, it has been a conventional technique to form evaluation patterns on the photoconductive drum 135. The evaluation patterns are a plurality of evaluation patterns which are drawn by repeatedly turning on and off the respective light emitters of the exposure device 137 for emitting the light beams in units of n dots to irradiate the light beams to the circumferential surface of the photoconductive drum 135 while changing write timings of the respective light emitters in a predetermined range. The write timings of the respective light emitters are adjusted by causing the density sensor 148 to detect these plurality of evaluation patterns and evaluating the detected densities. However, if there is density unevenness or density variation resulting from development characteristics, jitter caused by a conveyance system such as the transfer belt 131 or the like, density unevenness or variation may be possibly caused among the plurality of evaluation patterns. Even if the write timings of the light emitters are adjusted based on such evaluation patterns, precise adjustment cannot be made.

Accordingly, in the present discloser, the image forming apparatus 1 includes an adjustment unit for improving reliability of density difference information among the plurality of evaluation patterns. This adjustment unit fulfills a function of suppressing the influence of the above density unevenness or density variation on the plurality of evaluation patterns as much as possible. The control unit 300 (300A to 300C) obtains information on the densities of the respective evaluation patterns based on a detection result on the densities of the respective evaluation patterns by the density sensor 148. The write timings derived from the evaluation pattern having the lowest or highest density are determined as the write timings of the plurality of light emitters. This enables the write timings of the plurality of light emitters to be accurately adjusted. Several preferable specific embodiments of the above adjustment unit are shown below.

### First Embodiment

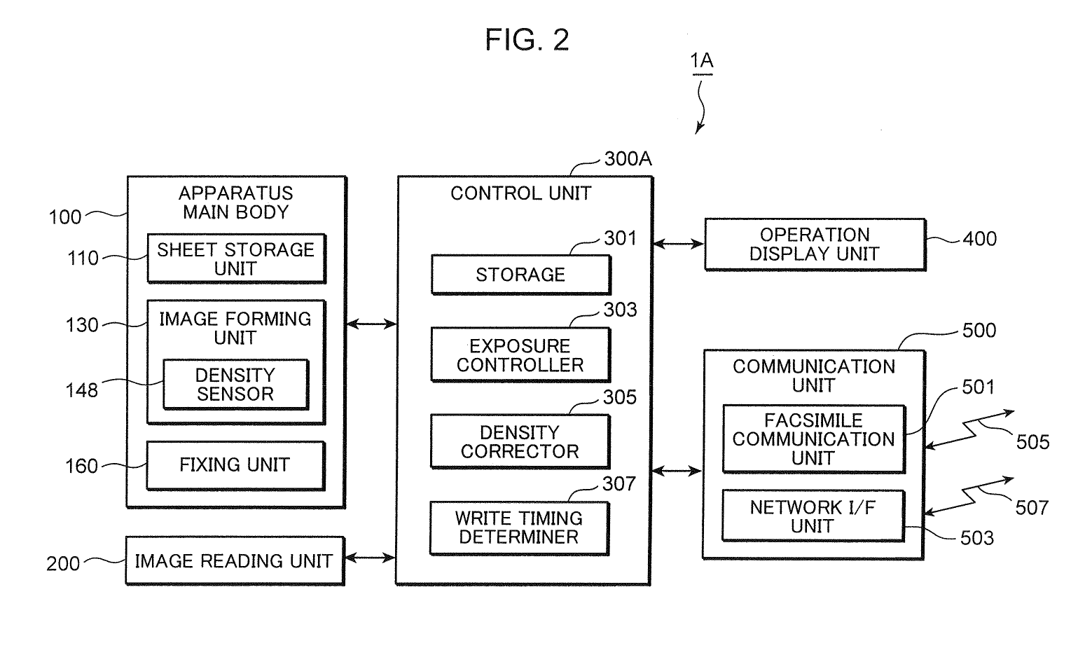

FIG. 2 is a block diagram showing the electrical construction of an image forming apparatus 1A according to a first embodiment. The image forming apparatus 1A includes an apparatus main body 100, an image reading unit 200, a control unit 300A, an operation display unit 400 and a communication unit 500, and these are connected to each other by a bus. The apparatus main body 100 and the image reading unit 200 are not described since having the same constructions described with reference to FIG. 1.

The control unit 300A includes a CPU (Central Processing Unit), a ROM (Read Only Memory), a RAM (Random Access Memory), an image memory and the like. The CPU executes a control necessary to operate the image forming apparatus 1A on the above hardware constituting the image forming apparatus 1A. The ROM stores software necessary to control the operation of the image forming apparatus 1A. The RAM is used to temporarily store data generated at the time of executing software and store application software, and the like. The image memory temporarily stores image data (image data output from the image reading unit 200, image data transmitted from a personal computer, facsimile-received image data or the like).

The control unit 300A includes a storage 301, exposure controllers 303 (pattern formation control unit), a density corrector 305 (adjustment unit) and a write timing determiner 307 (determination unit). Image data of respective colors used to form electrostatic latent images are stored in the storage 301. In this embodiment, image data of magenta, cyan, yellow and black are stored.

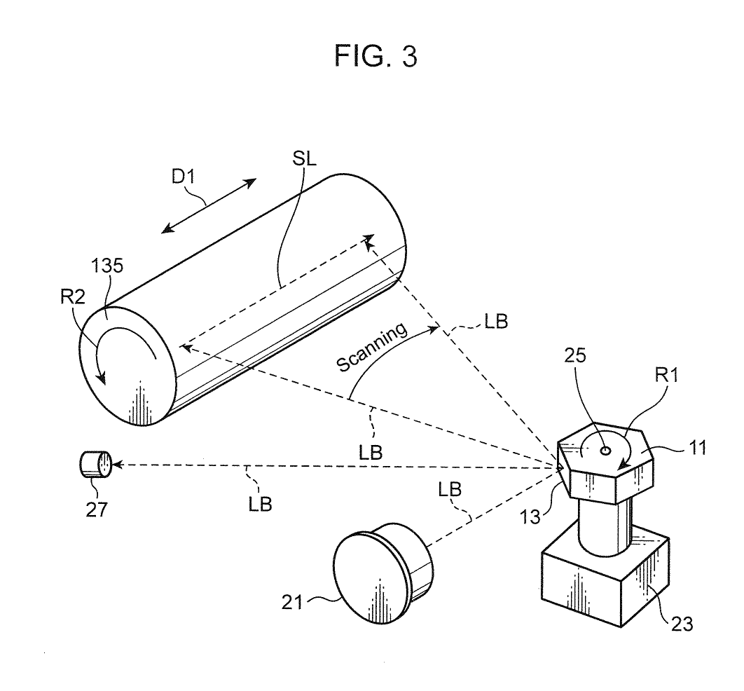

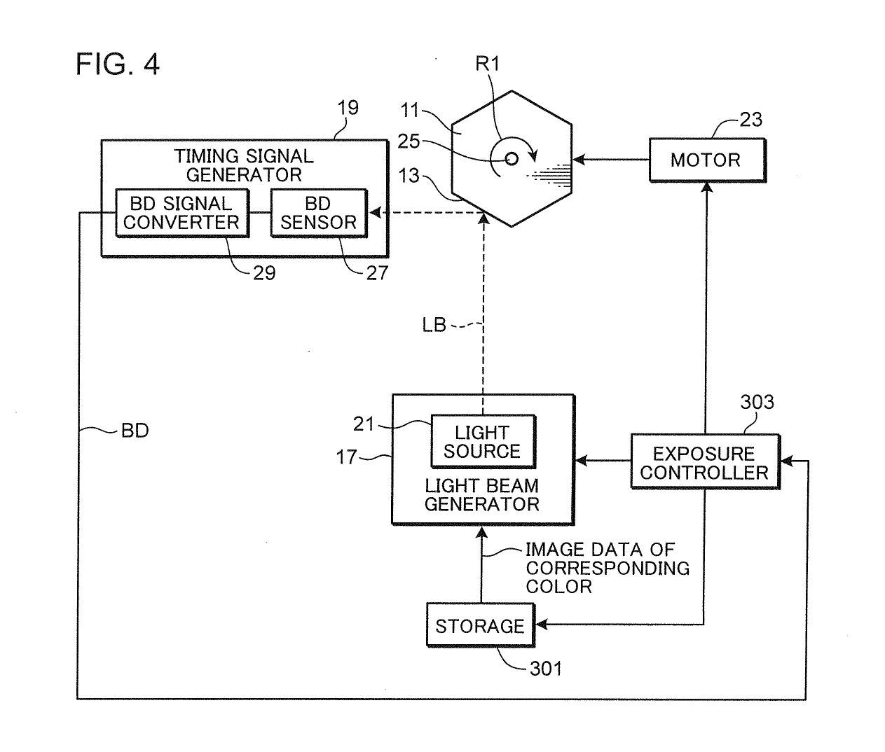

The exposure controllers 303 control the operation of exposure devices 137 and are provided in correspondence with the respective colors. Each exposure controller 303 causes a light beam generator 17 (FIG. 4) to be described later to generate a light beam modulated by the image data stored in the storage 301 while rotating a polygon mirror 11 (FIG. 3) by a motor, and causes the polygon mirror 11 to reflect the light beam. That is, the exposure controller 303 executes a control to form an electrostatic latent image on the photoconductive drum 135 using the light beam modulated by the image data.

The density corrector 305 causes the density sensor 148 to detect a density of a toner image on the transfer belt 131 and performs a density correction based on a detection result. The write timing determiner 307 determines an optimal write timing of each light emitter of a light source 21 (FIG. 3) based on the density corrected by the density corrector 305. These density correction and write timing determination method are described in detail later.

The operation display unit 400 includes operation keys which are hard keys; specifically includes a start key, a numerical pad, a stop key, a reset key, function switching keys used to switch among copy, printer, scanner and facsimile functions, and the like. Further, the operation display unit 400 includes a touch panel. Contents and the like of various operations and performances and operation keys, which are soft keys, are displayed on the screen of the touch panel.

The communication unit 500 includes a facsimile communication unit 501 and a network I/F unit 503. The facsimile communication unit 501 includes an NCU (Network Control Unit) for controlling connection with a telephone line to a destination facsimile machine and a modulation/demodulation circuit for modulating and demodulating a signal for facsimile communication. The facsimile communication unit 501 is connected to a telephone line 505.

The network I/F unit 503 is connected to a LAN (Local Area Network) 507. The network I/F unit 503 is a communication interface circuit for carrying out communication with terminal units such as personal computers connected to the LAN 507.

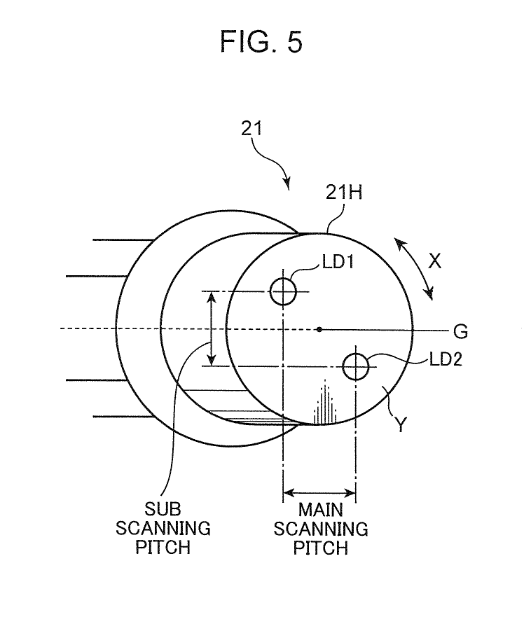

Next, a light beam irradiation control system for forming an electrostatic latent image on the circumferential surface of the photoconductive drum 135 is described with reference to FIGS. 3 to 5. FIG. 3 is a diagram showing a state where a light beam LB is irradiated to a light polarization surface 13 of the polygon mirror 11 provided in the exposure device 137, FIG. 4 is a block diagram showing the light beam irradiation control system and FIG. 5 is a perspective view showing the external appearance of the light source 21.

The irradiation control system shown in FIG. 4 is provided in correspondence with each color component of a full color image. In this embodiment, the irradiation control system is provided for each of magenta, cyan, yellow and black. Note that optical components such as a collimator lens and an fθ lens provided in the exposure device 137 are not shown. The irradiation control system includes the polygon mirror 11, the light beam generator 17, a timing signal generator 19, an exposure controller 303 and the like.

The light beam generator 17 is composed of the light source 21 for emitting a light beam LB, a drive circuit for driving the light source 21 and the like. A semiconductor laser is, for example, used as the light source 21. As shown in FIG. 5, the light source 21 includes a cylindrical light emitting head 21H and a plurality of laser diodes LD1 and LD2 (a plurality of light emitters) arranged in one row at a predetermined interval are unitized on a leading end surface Y of the light emitting head 21H. The light emitting head 21H is formed to be rotatable in a direction of an arrow X about an axis of rotation which is a normal G passing through the center out of normals to the leading end surface Y. In this embodiment, a monolithic multi-laser diode including two laser diodes is illustrated. In another embodiment, a laser diode in which two or more laser diodes are arranged in one row at a predetermined interval on the same chip may also be used.

If such a light source 21 is used, light beams emitted from the laser diodes LD1, LD2 are irradiated to the circumferential surface of the photoconductive drum 135, wherefore a plurality of lines can be drawn by one scanning. Further, the light source 21 is such that an arrangement direction of irradiation positions (imaging positions) of the respective light beams on the circumferential surface, i.e. a line connecting the laser diodes LD1, LD2, is at a predetermined angle of inclination with respect to a main scanning direction. Thus, by rotating the light emitting head 21H to adjust the angle of inclination, resolution in a sub scanning direction can be adjusted. Normally, a pitch in the sub scanning direction is determined in accordance with resolution specification of an apparatus and a pitch in the main scanning direction is also determined by this determination.

The polygon mirror 11 reflects the light beam LB generated by the light beam generator 17. The polygon mirror 11 is rotated in a rotation direction R1 about a rotary shaft 25 by a motor 23. The polygon mirror 11 has a right hexagonal side surface, which is composed of six light polarization surfaces 13.

The exposure controller 303 executes a control to draw an electrostatic latent image on the photoconductive drum 135 by irradiating the light beam LB. That is, the exposure controller 303 sends image data of the corresponding color stored in the storage 301 to the light beam generator 17 while rotating the polygon mirror 11 by the motor 23, and causes the light beam generator 17 to generate a light beam LB modulated by the image data. This generated light beam, i.e. the light beam LB emitted from the light source 21 is irradiated to the rotating polygon mirror 11 and polarized by the light polarization surface 13 (reflected by the polygon mirror 11) to draw a scanning line SL on the photoconductive drum 135 in a main scanning direction D1. One scanning line SL is drawn by one light polarization surface 13. By repeatedly drawing one scanning line SL on the rotating photoconductive drum 135 in this way, an electrostatic latent image is drawn along the sub scanning direction. The sub scanning direction corresponds to a rotation direction R2 of the photoconductive drum 135.

The timing signal generator 19 is provided in correspondence with each color and generates a timing signal BD called a BD (Beam Detect) signal. The timing signal BD is a signal as a basis for aligning writing positions in the main scanning direction D1 when an electrostatic latent image is drawn on the photoconductive drum 135. After the timing signal BD is output from the timing signal generator 19 and a predetermined period elapses, drawing of an electrostatic latent image on the photoconductive drum 135 is started by the light beam LB modulated by the image data.

The construction of the timing signal generator 19 is described. The timing signal generator 19 includes a BD sensor 27 and a BD signal converter 29. The light beam LB is repeatedly scanned in a scanning range longer than a dimension of the photoconductive drum 135 in the main scanning direction D1. The BD sensor 27 is disposed at a position, where the light beam LB is received before scanning of the photoconductive drum 135 with the light beam LB is started, out of the scanning range.

The BD sensor 27 is a photosensor. When receiving the light beam LB generated by the light beam generator 17 and reflected by the light polarization surfaces 13 of the rotating polygon mirror 11, the BD sensor 27 outputs a light reception signal to the BD signal converter 29. The BD signal converter 29 shapes the light reception signal into a rectangular-wave timing signal BD and outputs the timing signal BD to the exposure controller 303.

In the case of the light source 21 using such a multi-laser diode, the arrangement direction of the plurality of laser diodes is inclined (see FIG. 5) with respect to the main and sub scanning directions. Thus, when light beams are simultaneously emitted from the respective laser diodes, writing positions in the main scanning direction on the photoconductive drum 135 are shifted. If the writing positions are shifted, positional shifts occur in the respective lines in the main scanning direction, leading to image degradation. Accordingly, the writing positions in the main scanning direction need to be precisely matched by controlling emission timings (write timings) of the light beams.

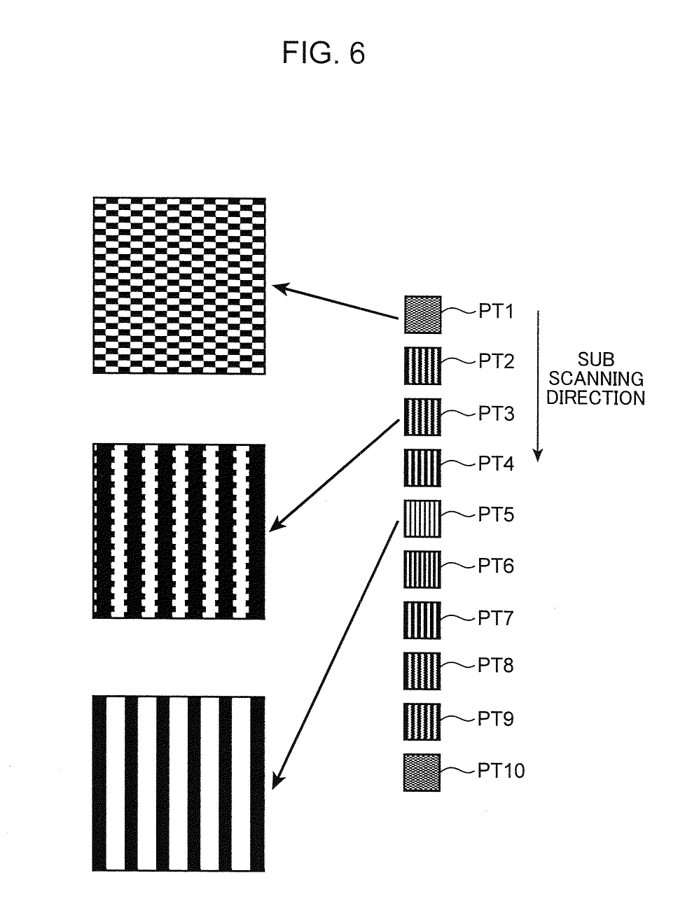

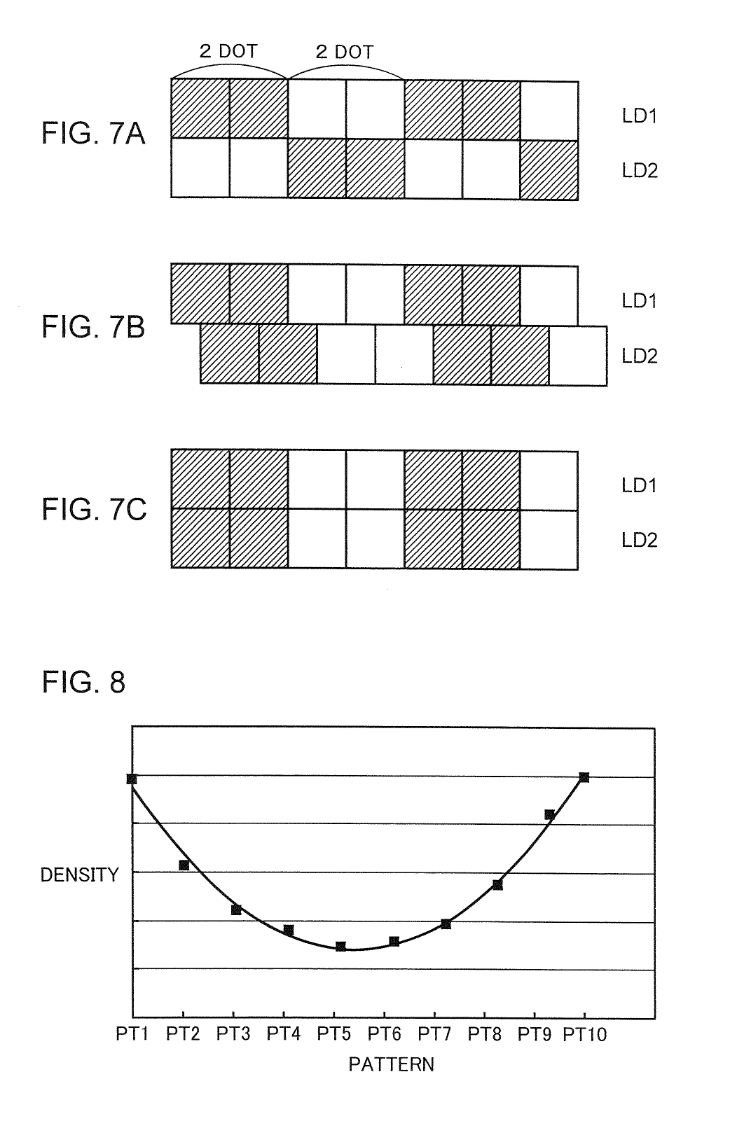

A method using an evaluation chart is generally used as this write timing adjustment method. FIG. 6 is a diagram showing an example of an evaluation chart and FIGS. 7 are diagrams enlargedly showing dots of parts of the evaluation chart. Respective patterns are referred to as “evaluation patterns” and the evaluation patterns PT1 to PT10 are collectively referred to as an “evaluation chart”. Further, the evaluation patterns PT1 to PT10 are merely referred to as “evaluation patterns PT” unless specific patterns are indicated.

The evaluation patterns are described using FIGS. 6 and 7. The respective evaluation patterns PT are common in that they are patterns drawn by emitting light beams in a repeating 2-dot-on and 2-dot-off pattern from the laser diodes LD1, LD2. The respective evaluation patterns PT differ in that the write timing of the laser diode LD2 is changed within a predetermined range with respect to that of the laser diode LD1. Thus, the evaluation patterns PT1 to PT10 are respectively different patterns.

More specifically, an ideal time difference in write timing in calculation based on a beam pitch between the laser diodes LD1 and LD2 in the main scanning direction (time difference of the write timing of the light source LD2 from the write timing of the laser diode LD1) is first calculated. Then, the write timing of the laser diode LD2 is changed, for example, in units of 0.1 [μs] with respect to the calculated ideal write timing. That is, if the ideal write timing is 3.0 [μs], the evaluation pattern is drawn while the write timing of the laser diode LD2 is altered (changed) to 2.8, 2.9, 3.0, 3.1, 3.2, 3.3 [μs] with 3.0 [μs] as a center.

If the write timings of the laser diodes LD1, LD2 match, 2-dot rows of lines corresponding to the laser diodes LD1, LD2 match as shown in FIG. 7C. However, if the write timings of the laser diodes LD1, LD2 do not match, the positions of 2-dot rows may be shifted as shown in FIGS. 7A and 7B. Here, a pattern corresponding to FIG. 7C in which the 2-dot rows match is PT5 of FIG. 6, and patterns corresponding to FIGS. 7A and 7B in which the dot positions are shifted are respectively PT1 and PT3.

FIG. 8 is a graph comparing the densities of the respective evaluation patterns PT1 to PT10, wherein a vertical axis represents density and a horizontal axis represents pattern number. It can be understood from FIG. 8 that the evaluation patterns PT1 and PT10 having a largest dot positional shift have highest density and the density decreases as the dot positional shift decreases. This is because white lines evidently appear if the dot rows match as shown in FIG. 7C and an average density of the pattern is decreased that much. If this characteristic is used, it can be said that the write timings of the laser diodes LD1, LD2 when the pattern having the lowest density was drawn are timings at which the dot positional shift is least.

However, even if the write timings are adjusted using the evaluation chart as shown in FIG. 6, density unevenness or density variation may occur in the evaluation chart due to density unevenness or density variation resulting from development characteristics, jitter caused by a conveyance system such as a transfer belt or the like. If there is density unevenness or density variation in the evaluation chart, an error occurs in the measured densities of the respective evaluation patterns PT and the write timings of the laser diodes LD1, LD2 cannot be accurately adjusted only simply by comparing the measured densities.

In the first embodiment, in order to improve reliability of density difference information among the respective evaluation patterns PT, the write timings of the laser diodes LD1, LD2 are precisely adjusted by comparing the densities after a noise component dependent on apparatus characteristics is canceled from the densities of the evaluation patterns PT.

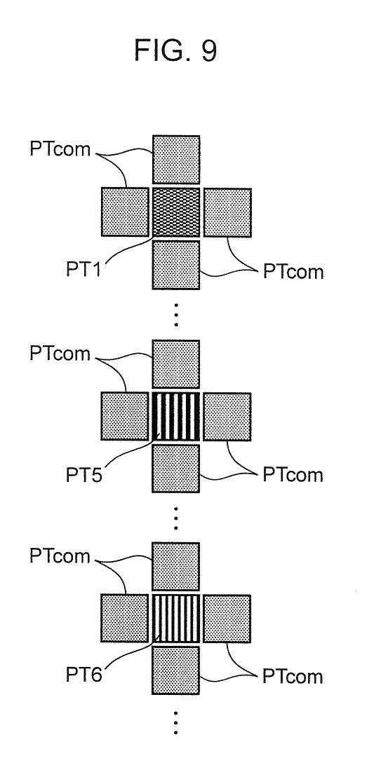

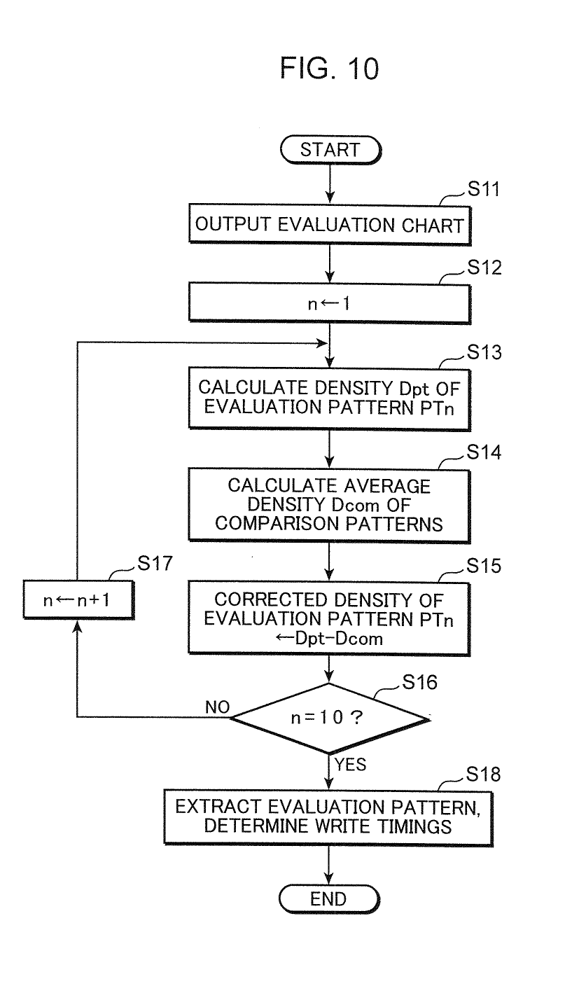

FIG. 9 is a diagram showing an example of an evaluation chart to which the first embodiment is applied. Evaluation patterns PT1, PT5 and PT6 in FIG. 9 are similar to those denoted by the same reference numerals out of the evaluation patterns shown in FIG. 6. FIG. 10 is a flow chart showing a process of adjusting the write timings of the laser diodes LD1, LD2. The method for adjusting the write timings of the laser diodes LD1, LD2 is described using FIGS. 9 and 10.

First, the exposure controller 303 causes the image forming unit 130 to draw evaluation patterns PT1 to PT10 having different write timings and comparison patterns PTcom around the respective patterns as shown in FIG. 9 (Step S11). This comparison pattern PTcom is a fixed pattern of predetermined conditions and, for example, a pattern drawn by using only the laser diode LD1 (or laser diode LD2) and repeating the 2-dot-on and 2-dot-off pattern under the same exposure condition as at the time of forming the evaluation patterns PT. The exposure controller 303 causes a plurality of comparison patterns PTcom to be drawn near each evaluation pattern PT, such as by arranging the comparison patterns PTcom at sides upstream and downstream of the evaluation pattern PT in the main scanning direction and the sub scanning direction (upper, lower, left and right sides of the evaluation pattern PT on the plane of FIG. 9).

Note that although four comparison patterns PTcom are arranged near each evaluation pattern PT in the example shown in FIG. 9, a maximum of eight comparison patterns may be drawn by additionally arranging comparison patterns at positions diagonal to the evaluation pattern PT. Alternatively, a comparison pattern PTcom may be continuously drawn to surround the evaluation pattern PT.

Subsequently, the density corrector 305 causes the density sensor 148 to measure the density of the evaluation pattern PT and calculates a density Dpt of the evaluation pattern PT based on this measurement result (Step S13). Similarly, the density corrector 305 causes the density sensor 148 to measure the densities of a plurality of comparison patterns PTcom drawn near the density-measured evaluation pattern PT in Step S13 and calculates an average value of a plurality of measurement results as a density Dcom of the comparison patterns PTcom (Step S14). Note that if the comparison pattern PTcom is continuously drawn to surround the evaluation pattern PT, a plurality of density measurement positions are set beforehand and the density corrector 305 causes density detection to be made at the set measurement positions and calculates an average density.

Then, the density corrector 305 calculates a difference value by subtracting the density Dcom of the comparison patterns PTcom from the density Dpt of the evaluation pattern PT and sets the calculated value as a corrected density of the evaluation pattern PT (Step S15). The density corrector 305 repeats this process for the evaluation patterns PT1 to PT10 (Steps S16 and S17).

By drawing a plurality of comparison patterns PTcom near the evaluation pattern PT and using the average value of the densities of the respective comparison patterns PTcom in this way, the influence of density unevenness and density variation resulting from development characteristics, jitter caused by a conveyance system such as a transfer belt or the like can be reduced. By subtracting the average density of the comparison patterns PTcom from the density of the evaluation pattern PT, a noise component resulting from the development characteristics and the like can be canceled.

Subsequently, the write timing determiner 307 extracts the evaluation pattern PT having the lowest density out of the corrected densities of the respective evaluation patterns PT and determines the write timings when this evaluation pattern PT was drawn as the write timings of the laser diodes LD1, LD2 (Step S18). Note that the write timing determiner 307 may extract the evaluation pattern PT having the highest density and determine the write timings of the laser diodes LD1, LD2 based on the write timings when this evaluation pattern PT was drawn. In short, if a peak value of a graph of the corrected densities of the respective evaluation patterns PT is turned out, the timings can be adjusted based on the write timings corresponding to this peak value.

According to the first embodiment, a plurality of fixed comparison patterns PTcom are output near each evaluation pattern PT when an evaluation chart is output. By subtracting an average density of the comparison patterns PTcom from the density of the evaluation pattern PT, a noise component resulting from the development characteristics and the like can be canceled and a relative density of the evaluation pattern PT can be precisely grasped. Since this enables precise extraction of an extreme value of the density of the evaluation pattern having the lowest or highest density out of the evaluation patterns PT, the write timings of the laser diodes LD1, LD2 can be accurately adjusted.

Further, since a plurality of comparison patterns PTcom are formed around the evaluation pattern PT and the density Dcom as an average value is calculated, a noise component resulting from the development characteristics and the like and contained in the measured densities of the comparison patterns can be reduced. By subtracting the average density Dcom from the density of each evaluation pattern PT, the relative density of each evaluation pattern having the noise component canceled can be precisely grasped.

### Second Embodiment

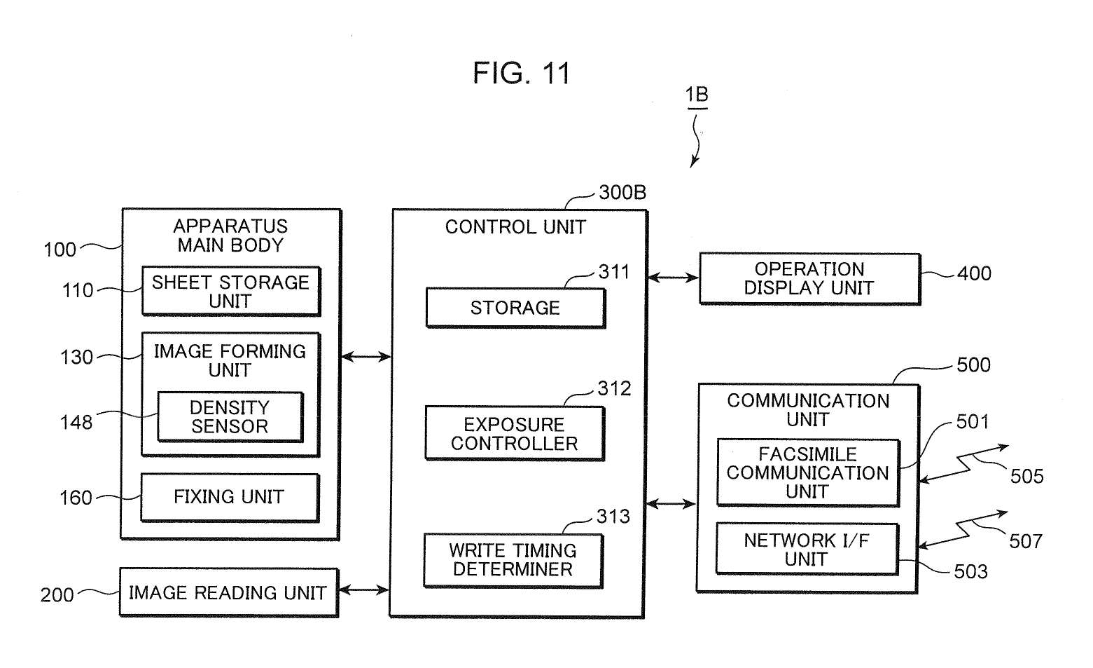

FIG. 11 is a block diagram showing the electrical construction of an image forming apparatus 1B according to a second embodiment. The same parts as the image forming apparatus 1A of the first embodiment are denoted by the same reference numerals and not described here.

In the second embodiment, as a mode of the above adjustment unit, the write timings of the laser diodes LD1, LD2 are precisely adjusted by increasing an exposure light quantity (hereinafter, merely referred to as a “light quantity”) of a light source 21 to make contrasting densities of evaluation patterns clearer and improving precision of densities of the respective evaluation patterns PT detected by a density sensor 148 when an evaluation chart is output.

The image forming apparatus 1B includes a control unit 300B for controlling the operation of the image forming apparatus 1B. The control unit 300B includes a storage 311, exposure controllers 312 (adjustment unit and pattern formation control unit in second embodiment) and write timing determiners 313 (determination unit). Image data of respective colors used to draw electrostatic latent images, i.e. image data of magenta, cyan, yellow and black are stored in the storage 311.

The exposure controllers 312 control the operation of the exposure devices 137 and are provided in correspondence with the respective colors. Each exposure controller 312 causes a light beam generator 17 (FIG. 4) to generate a light beam modulated by the image data stored in the storage 311 while rotating a polygon mirror 11 (FIG. 3) by a motor, and causes the polygon mirror 11 to reflect the light beam. That is, the exposure controller 312 executes a control to draw an electrostatic latent image on a photoconductive drum 135 using the light beam modulated by the image data. The exposure controller 312 also executes a control to form evaluation patterns PT with a light quantity larger than that of a light emitter 21 when an image forming unit 130 forms a normal image in order to make contrasting densities of the respective evaluation patterns PT clearer.

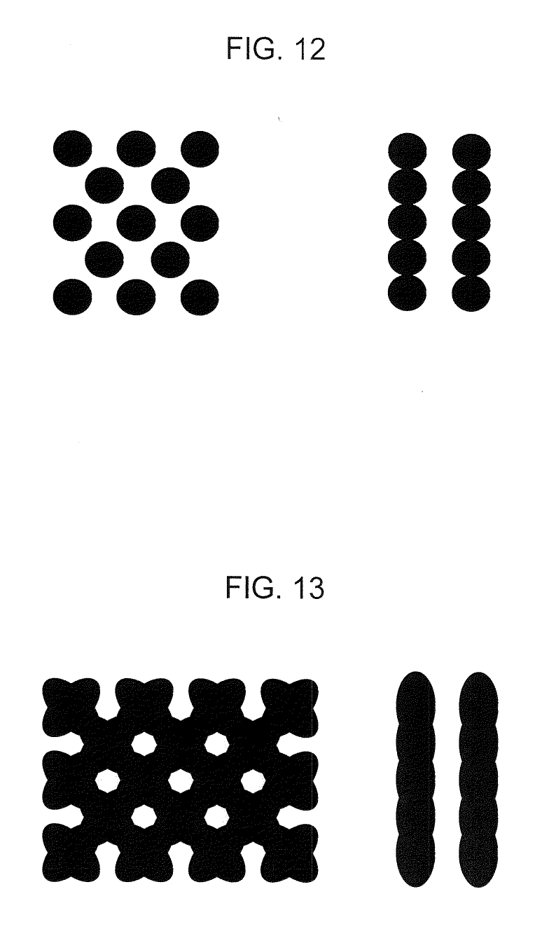

FIG. 12 is a view diagrammatically showing dots formed when the light quantity of the light source 21 is small. Since beam diameters of laser diodes LD1, LD2 become smaller if the light quantity is small as shown in FIG. 12, adjacent dotes become isolated from each other (left side of FIG. 12) or overlap to a smaller degree (right side of FIG. 12). Accordingly, density differences become difficult to appear in the evaluation patterns PT, i.e. differences in detected density by the density sensor 148 among the evaluation patterns PT become smaller. If this happens, precision in determining the evaluation pattern PT having the lowest density is reduced by even slight density unevenness, variation or the like when an error is included in the detected densities of the respective evaluation patterns PT.

FIG. 13 is a view diagrammatically showing dots to which the second embodiment is applied. The exposure controller 312 controls the image forming unit 130 so as to increase the light quantity when an evaluation chart is formed larger than when a normal image is formed. As shown in FIG. 13, overlapping degrees between the dots increase and the contrasting densities of the evaluation patterns PT become clearer as the light quantity increases. Accordingly, differences in detected density by the density sensor 148 among the evaluation patterns PT become larger, wherefore precision in discriminating the evaluation pattern PT having the lowest density is improved.

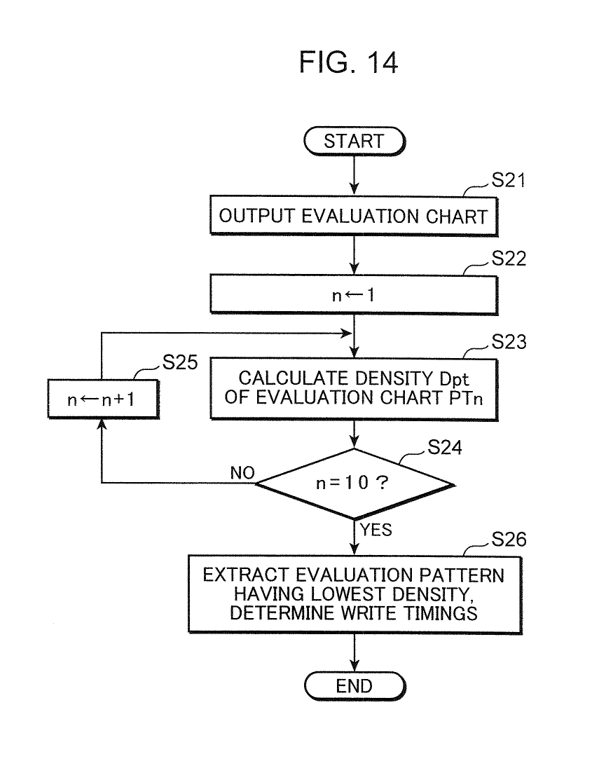

FIG. 14 is a flow chart showing a process of adjusting the write timings of the laser diodes LD1, LD2, to which process the second embodiment is applied. First, the exposure controller 312 causes the image forming unit 130 to draw evaluation patterns PT1 to PT10 having different write timings as shown in FIG. 6 (Step S21). At this time, the exposure controller 312 controls the image forming unit 130 so as to increase the light quantity than when a normal image is formed. Then, the control unit 300B causes the density sensor 148 to measure densities of the evaluation patterns PT1 to PT10 and calculates a density Dpt of the evaluation patterns PT based on this measurement result (Steps S22, S24 and S25).

Subsequently, the write timing determiner 313 extracts the evaluation pattern PT having the lowest density out of the densities of the respective evaluation patterns PT and determines the write timings when this evaluation pattern PT was drawn as the write timings of the laser diodes LD1, LD2 (Step S26).

According to the second embodiment, the exposure controller 312 controls the image forming unit 130 to increase the light quantity when an evaluation chart is formed larger than when a normal image is formed. Overlapping degrees between dots increase and the contrasting densities of the evaluation patterns PT become clearer by increasing the light quantity. Accordingly, differences in detected density by the density sensor 148 among the evaluation patterns PT become larger, wherefore precision in discriminating the evaluation pattern PT having the lowest density is improved. In this way, the write timings of the laser diodes LD1, LD2 can be precisely adjusted.

Note that, in this embodiment, the write timings of the laser diodes LD1, LD2 are determined using the write timings when the evaluation pattern PT having the lowest density out of the densities of the respective evaluation patterns PT was drawn. Contrary to this, the evaluation pattern PT having the highest density may be extracted and the write timings of the laser diodes LD1, LD2 may be determined using the write timings when this evaluation pattern PT was drawn.

### Third Embodiment

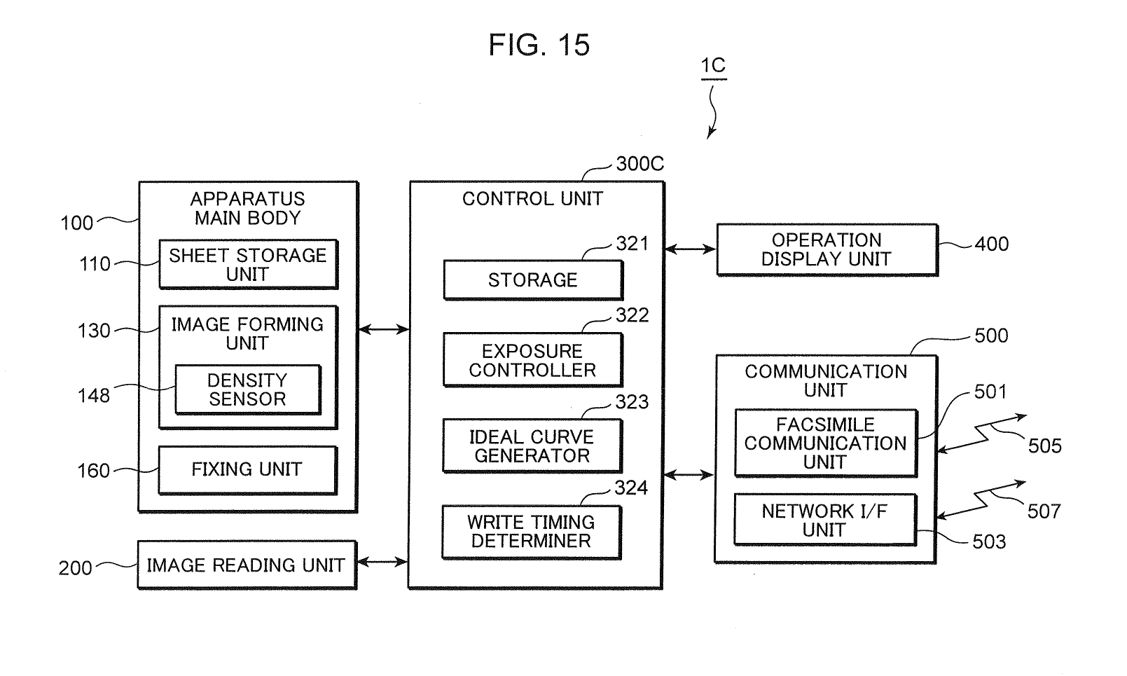

FIG. 15 is a block diagram showing the electrical construction of an image forming apparatus 1C according to a third embodiment. The same parts as the image forming apparatus 1A of the first embodiment are denoted by the same reference numerals and not described here.

In the third embodiment, as a mode of the above adjustment unit, the write timings of the laser diodes LD1, LD2 are precisely adjusted by forming a plurality of evaluation charts side by side in a main scanning direction while a shift amount between write timings of the laser diodes LD1, LD2 (FIG. 5) of a light source 21 is made different. By forming the evaluation charts in this way, (1) the sample number of density measurements is increased by using a plurality of evaluation charts and (2) the position of an evaluation pattern having the lowest or highest density in each evaluation chart can be grasped by making the shift amount between the write timings of the laser diodes LD1, LD2 different. Thus, it becomes possible to adjust the write timings while suppressing the influence of noise caused by density unevenness and variation of the evaluation charts.

The image forming apparatus 1C includes a control unit 300C for controlling the operation of the image forming apparatus 1C. The control unit 300C includes a storage 321, exposure controllers 322 (pattern formation control unit and a part of an adjustment unit), an ideal curve generator 323 (a part of the adjustment unit) and write timing determiners 324 (determination unit). Image data of respective colors used to draw electrostatic latent images, i.e. image data of magenta, cyan, yellow and black are stored in the storage 321.

The exposure controllers 322 control the operation of the exposure devices 137 and are provided in correspondence with the respective colors. Each exposure controller 322 causes a light beam generator 17 (FIG. 4) to generate a light beam modulated by the image data stored in the storage 321 while rotating a polygon mirror 11 (FIG. 3) by a motor, and causes the polygon mirror 11 to reflect the light beam. That is, the exposure controller 322 executes a control to draw an electrostatic latent image on a photoconductive drum 135 using the light beam modulated by the image data. The exposure controller 322 also executes a control to form a plurality of evaluation charts, each of which includes a plurality of evaluation patterns arranged in a sub scanning direction, side by side in a main scanning direction.

The ideal curve generator 323 calculates an ideal curve using the positions of the evaluation patterns having the lowest or highest density in the respective evaluation charts arranged in the main scanning direction. The write timing determiner 324 determines an optimal write timing of each light emitter of a light source 21 based on a measurement result of a density sensor 148.

A left side of FIG. 16 shows an example of evaluation charts to which the third embodiment is applied. Each evaluation chart includes a plurality of evaluation patterns arranged in the sub scanning direction, and the evaluation charts are arranged in the main scanning direction. Evaluation charts CT11, CT12, CT13, CT14 and CT15 are arranged from the left side of FIG. 16. Hereinafter, these are merely referred to as “evaluation charts CT” unless specific evaluation charts are indicated. Further, a cycle from one matching timing of formed dot rows to the next matching timing by successively shifting the write timings of the laser diodes LD1, LD2 by a predetermined time is referred to as a “shift cycle”. The respective evaluation charts CT have different lengths in the sub scanning direction since having different shift cycles.

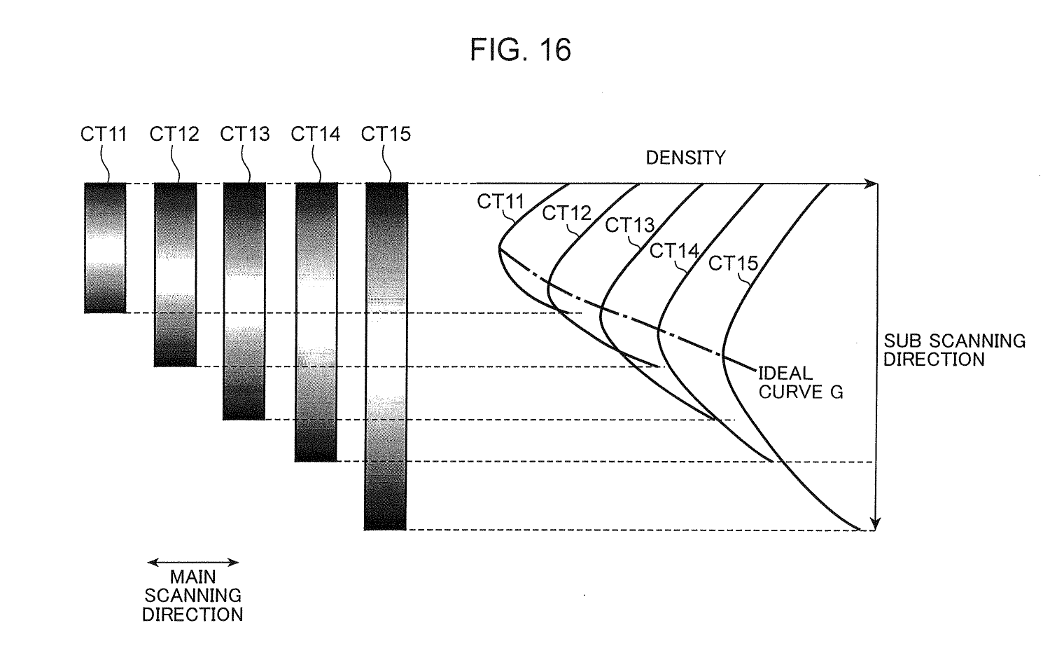

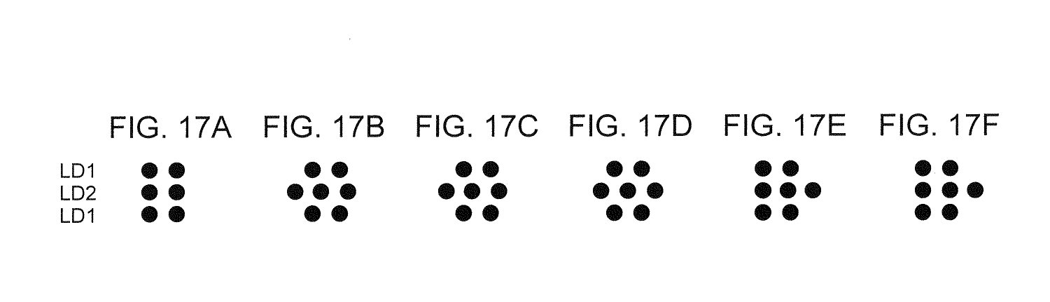

FIGS. 17A to 17F are views showing the shift cycle. FIG. 17A is a view when dot rows are formed without being shifted by advancing the write timing of the laser diode LD2 relative to that of the laser diode LD1 by a predetermined time t0. FIG. 17B is a view when the write timing of the laser diode LD2 is advanced by a time t as compared with the case of FIG. 17A, and the positions of dot rows are shifted. FIG. 17C is a view when the write timing of the laser diode LD2 is advanced by the time t as compared with the case of FIG. 17B.

If the write timing is successively advanced by the time t from the time difference t0 between the laser diodes LD1, LD2 when the dot rows match as a basis in this way, a timing comes at which the dot rows match again as shown in FIG. 17F. That is, the “shift cycle” defined above means a period until the write timings when the dot rows of FIG. 17F are formed are reached by successively changing the write timings by the time t from the write timings when the dot rows of FIG. 17A are formed as a basis.

Referring back to FIG. 16, the respective evaluation charts CT have different “shift cycles” described above. For example, if the evaluation chart CT11 is made up of patterns formed by changing the write timing by a time T, the evaluation chart CT12 is made up of patterns formed by changing the write timing by a time T−α (=T1). Further, the evaluation chart CT13 is made up of patterns formed by changing the write timing by a time T1−α. In this way, by shifting the write timing by a different amount in each evaluation chart CT, the shift cycle is changed. That is, the lengths of the respective evaluation charts CT in the sub scanning direction are made different.

The evaluation pattern constituting each evaluation chart CT and formed by the same write timings may only has to be drawn for an area measurable by the density sensor 148. For example, the evaluation pattern may be formed over a length of about 16 dots in the sub scanning direction.

The control unit 300C causes the density sensor 148 to measure the densities of the respective evaluation charts CT and the ideal curve generator 323 calculates an ideal curve using positions where the density is lowest or highest in the respective evaluation charts CT. Graphs on the right side of FIG. 16 are used to describe this ideal curve. The ideal curve generator 323 generates an ideal curve G by connecting peak values (positions where the density is lowest or highest) of the respective graphs. Alternatively, an approximation curve is generated from the peak values of the respective graphs and set as the ideal curve G.

If the peak values of the respective graphs are located on this ideal curves G, the write timing determiner 324 determines the write timings when the evaluation patterns corresponding to the peak values as the write timings of the laser diodes LD1, LD2. On the other hand, the write timing determiner 324 deletes the graph whose peak value is not located on the ideal curve G, and determines the write timings using only the graphs whose peak values are located on the ideal curve G.

In this way, the sample number of density measurements increases by using a plurality of evaluation charts CT, and a line connecting the positions of the respective evaluation charts CT where the density is lowest or highest is made oblique to the main and sub scanning directions by making the shift cycles of the respective evaluation charts CT arranged in the main scanning direction different. Accordingly, the evaluation patterns PT having the lowest or highest density can be formed not only at specific positions, but in a wide range, wherefore the write timing determiner 324 can determine the write timings of the laser diodes LD1, LD2 while the influence of density unevenness and variation of the evaluation charts CT is reduced.

In the above embodiment is illustrated the method in which the ideal curve generator 323 calculates the ideal curve G using the positions where the density is lowest or highest in the respective evaluation charts CT and the write timing determiner 324 determines the write timings using the graphs whose peak values are located on the ideal curve G.

Next, a method for detecting an evaluation pattern having the lowest or highest density for each evaluation chart, extracting the most detected evaluation pattern out of the detected evaluation patterns, and determining the write timings adopted when this extracted evaluation pattern was formed as the write timings is illustrated as a modification of the third embodiment.

A block diagram showing the electrical construction of an image forming apparatus 1C according to this modification is the block diagram of FIG. 15 minus the ideal curve generator 323.

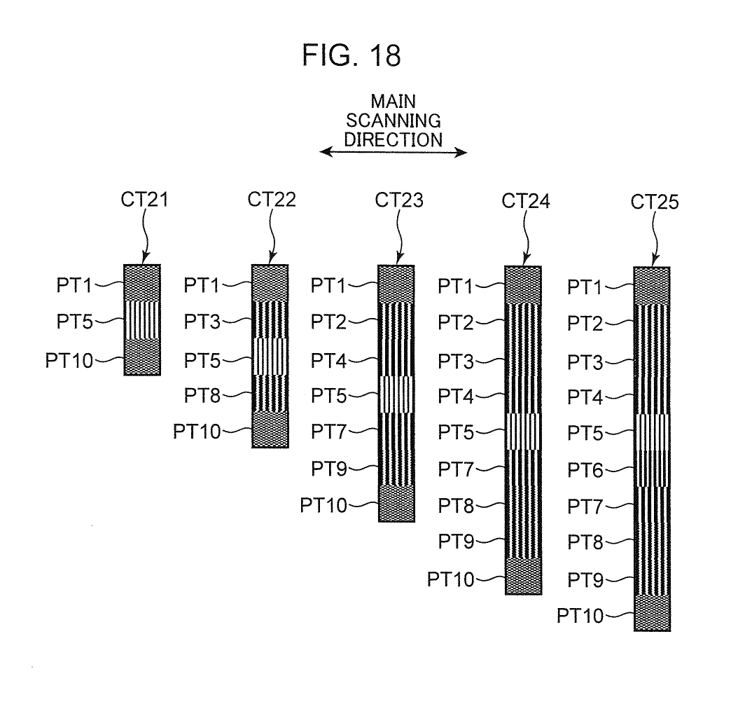

FIG. 18 is a diagram showing an example of evaluation charts CT in this modification. The respective evaluation charts CT have different shift cycles. Specifically, an evaluation chart CT21 has one cycle made up of three patterns, i.e. evaluation patterns PT1, PT5 and PT10. Similarly, an evaluation chart CT22 has one cycle made up of five patterns, i.e. evaluation patterns PT1, PT3, PT5, PT8 and PT10, an evaluation chart CT23 has one cycle made up of seven patterns, an evaluation chart CT 24 has one cycle made up of nine patterns and an evaluation chart CT25 has one cycle made up of ten patterns.

By making the shift cycle different for each of the evaluation charts CT arranged in the main scanning direction in this way, the position of the evaluation pattern PT having the lowest (e.g. evaluation pattern PT5) or highest density is supposed to be ideally shifted in the sub scanning direction. In other words, the positions of the evaluation patterns PT having the lowest or highest density is supposed to be shifted obliquely to the main and sub scanning directions. However, if there is density unevenness or variation in the evaluation charts CT due to density unevenness or variation resulting from development characteristics, jitter or the like, the evaluation pattern PT having the lowest or highest density may possibly differ depending on the evaluation chart CT.

Accordingly, the write timing determiner 324 extracts the evaluation pattern PT having the lowest or highest density for each evaluation chart CT using the densities measured by the density sensor 148, determines the most detected evaluation pattern out of the extracted evaluation patterns PT and determines the write timings adopted when the determined evaluation pattern was formed as the write timings of the laser diodes LD1, LD2.

More specifically, it is assumed that the evaluation pattern having the lowest density in the evaluation charts CT21, CT22, CT23 and CT24 is PT5 and the evaluation pattern having the lowest density in the evaluation chart CT25 is PT6. In this case, the write timing determiner 324 determines the write timings adopted when the evaluation pattern PT5, which is the evaluation pattern most detected to be the one having the lowest density, was formed, as the write timings of the laser diodes LD1, LD2. By doing so, the evaluation chart affected by density unevenness or variation can be excluded and the write timings of the laser diodes LD1, LD2 can be precisely adjusted.

Although the present discloser has been fully described by way of example with reference to the accompanying drawings, it is to be understood that various changes and modifications will be apparent to those skilled in the art. Therefore, unless otherwise such changes and modifications depart from the scope of the present discloser hereinafter defined, they should be construed as being included therein.

What is claimed is:

1. An image forming apparatus, comprising:
an image forming unit including a photoconductor and a light source with a plurality of light emitters arranged in a row at a predetermined interval and at a predetermined angle with respect to a main scanning direction of the photoconductor and adapted to form an electrostatic latent image on the photoconductor by emitting light corresponding to image data from the light source and form a toner image by developing the electrostatic latent image formed on the photoconductor with toner;
a detection unit for detecting a density of the toner image;
a pattern formation control unit for forming a plurality of evaluation patterns by repeatedly turning on and off the light emitters in units of n dots (n is an integer equal to or greater than 1) to irradiate light to the photoconductor while changing write timings of the respective light emitters in a predetermined range;
an adjustment unit for improving reliability of density difference information among the plurality of evaluation patterns; and
a determination unit for obtaining information on densities of the respective evaluation patterns based on a detection result on the densities of the respective evaluation patterns by the detection unit and determining write timings derived from the evaluation pattern having the lowest or highest density as the write timings of the plurality of light emitters.

2. An image forming apparatus according to claim 1, wherein:
the pattern formation control unit further forms predetermined fixed comparison patterns near the respective evaluation patterns;
the adjustment unit is a density corrector for causing the detection unit to detect densities of the respective evaluation patterns and the respective comparison patterns and calculating values obtained by subtracting the densities of the comparison patterns formed near the evaluation patterns from the densities of the evaluation patterns as corrected densities of the evaluation patterns; and
the determination unit determines the write timings adopted when the evaluation pattern having the lowest or highest density out of the calculated corrected densities was formed as the write timings of the plurality of light emitters.

3. An image forming apparatus according to claim 2, wherein:
the pattern formation control unit forms a plurality of comparison patterns near each evaluation pattern; and
the density corrector sets a value obtained by subtracting an average value of the densities of the plurality of comparison patterns formed near the evaluation pattern from the density of the evaluation pattern as the corrected density of the evaluation pattern.

4. An image forming apparatus according to claim 1, wherein:
the adjustment unit causes the evaluation patterns to be formed with an exposure light quantity larger than that of the light emitters when a normal image is formed; and
the determination unit causes the detection unit to detect the densities of the respective evaluation patterns and determines the write timings adopted when the evaluation pattern having the lowest or highest density out of the detected densities was formed as the write timings of the plurality of light emitters.

5. An image forming apparatus according to claim 1, wherein:
the pattern formation control unit includes a function of the adjustment unit and controls the image forming unit to form an evaluation chart by arranging the plurality of evaluation patterns in a sub scanning direction and form a plurality of evaluation charts having different shift cycles in the main scanning direction when the shift cycle is a period from one matching timing of formed dot rows to the next matching timing by successively shifting the write timings of the respective light emitters by a predetermined time; and
the determination unit calculates an ideal curve using positions where the density is lowest or highest in the respective evaluation charts and determines the write timings of the plurality of light emitters based on the ideal curve.

6. An image forming apparatus according to claim 1, wherein:
the pattern formation control unit includes a function of the adjustment unit and controls the image forming unit to form an evaluation chart by arranging the plurality of evaluation patterns in a sub scanning direction and form a plurality of evaluation charts having different shift cycles in the main scanning direction when the shift cycle is a period from one matching timing of formed dot rows to the next matching timing by successively shifting the write timings of the respective light emitters by a predetermined time; and
the determination unit detects the evaluation pattern having the lowest or highest density for each evaluation chart, extracts most detected evaluation pattern out of the detected evaluation patterns, and determines the write timings adopted when the extracted evaluation pattern was formed as the write timings of the plurality of light emitters.

7. An electrostatic latent image formation method for forming an electrostatic latent image on a photoconductor by emitting light corresponding to image data from a light source, using the photoconductor and the light source with a plurality of light emitters arranged in a row at a predetermined interval and at a predetermined angle with respect to a main scanning direction of the photoconductor, comprising:
forming a plurality of evaluation patterns by repeatedly turning on and off the light emitters in units of n dots (n is an integer equal to or greater than 1) to irradiate light to the photoconductor while changing write timings of the respective light emitters in a predetermined range;
performing an adjustment process of improving reliability of density difference information among the plurality of evaluation patterns;
detecting densities of the respective evaluation patterns;
obtaining information on the densities of the respective evaluation patterns based on a detection result on the densities; and
determining write timings derived from the evaluation pattern having the lowest or highest density as the write timings of the plurality of light emitters.

8. An electrostatic latent image formation method according to claim 7, wherein:
forming predetermined fixed comparison patterns respectively near the respective evaluation patterns;
detecting densities of the respective comparison patterns in detecting the densities of the respective evaluation patterns; and
calculating, as the adjustment process, values obtained by subtracting the densities of the comparison patterns formed near the evaluation patterns from the densities of the evaluation patterns as corrected densities of the evaluation patterns; and
determining the write timings adopted when the evaluation pattern having the lowest or highest density out of the calculated corrected densities was formed as the write timings of the plurality of light emitters.

9. An electrostatic latent image formation method according to claim 7, wherein, as the adjustment process,
forming the evaluation patterns with an exposure light quantity larger than that of the light emitters when a normal image is formed; and
determining the write timings adopted when the evaluation pattern having the lowest or highest density out of the detection result on the densities of the respective evaluation patterns was formed as the write timings of the plurality of light emitters.

10. An electrostatic latent image formation method according to claim 7, wherein, as the adjustment process,
forming a first evaluation chart by arranging the plurality of evaluation patterns in a sub scanning direction;
arranging a plurality of evaluation charts having shift cycles different from the first evaluation chart and another evaluation chart in the main scanning direction when the shift cycle is a period from one matching timing of formed dot rows to the next matching timing by successively shifting the write timings of the respective light emitters by a predetermined time;
calculating an ideal curve by using positions where the density is lowest or highest in the respective evaluation charts; and
determining the write timings of the plurality of light emitters based on the ideal curve.
